(19) United States
(12) Patent Application Publication
(10) Pub. No.: US 2025/0045634 A1
(43) Pub. Date: Feb. 6, 2025

(54) DATA TABLE ROW TO VECTOR EMBEDDING

(71) Applicant: Snowflake Inc., Bozeman, MT (US)

(72) Inventors: Luke Samuel Merrick, San Diego, CA (US); Abishek Sridhar, Pittsburgh, PA (US)

(21) Appl. No.: 18/759,210

(22) Filed: Jun. 28, 2024

Related U.S. Application Data
(60) Provisional application No. 63/517,858, filed on Aug. 4, 2023.

(51) Int. Cl. G06N 20/00; G06F 16/22

(52) U.S. Cl. CPC G06N 20/00; G06F 16/2282

(57) ABSTRACT

Various embodiments described herein provide for systems, methods, devices, instructions, and like for facilitating generation of a row embedding for a row of data table (e.g., of a database system). In particular, various embodiments provide for training and subsequent use of a transformer for generating row embeddings for one or more rows of a data table, where each of the one or more rows share the same plurality of fields (or cells).

### CROSS-REFERENCE TO RELATED APPLICATIONS

This application claims priority to and the benefit of U.S. Provisional Patent Application No. 63/517,858, filed on Aug. 4, 2023, which is incorporated herein by reference.

### TECHNICAL FIELD

Embodiments of the disclosure relate generally to embeddings and, more specifically, to a vector embedding generated for a row of a data table.

### BACKGROUND

Data analytics and machine learning techniques are increasingly being applied to tabular data (e.g., data tables) stored in rows and columns. Examples of such tabular data include, without limitation, spreadsheets, database tables, and CSV files. Generally, conventional machine learning techniques usually rely on manual feature engineering to convert raw data into numerical features usable by algorithms. Manual feature engineering is time-consuming and tailored to specific datasets. Additionally, current deep learning techniques are usually designed for sequential data like text or images and not two-dimensional structure of tabular data.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, according to some embodiments.

FIG. 2 is a diagram illustrating the components of a compute service manager, according to some embodiments.

FIG. 3 is a diagram illustrating components of an execution platform, according to some embodiments.

FIG. 4 is a flowchart of an example method for training a transformer for generating a row embedding for a row of a data table, according to some embodiments.

FIG. 5 is a flowchart of example method for using a transformer to generate a row embedding for a row of a data table, according to some embodiments.

FIG. 6 is a diagram of an example row embedding generator during training for generation of row embeddings for rows from a data table, according to some embodiments.

FIG. 7 is a diagram of an example row embedding generator during generation of a row embedding for a row of a data table, according to some embodiments.

FIG. 8 illustrates a diagrammatic representation of a machine in the form of a computer system within which a set of instructions may be executed for causing the machine to perform any one or more of the methodologies discussed herein, according to some embodiments.

### DETAILED DESCRIPTION

Reference will now be made in detail to specific embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform may include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a data platform, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

Currently, it is challenging to generate mathematical representations of data table rows that capture semantic similarities and differences between data table rows (e.g., of a data platform). Conventional techniques for training deep learning models on tabular data have limitations in handling mixed data types in tables, and fail to capture semantic relationships between table rows. These and other deficiencies of conventional technologies are cured or otherwise addressed by technical solutions provided by some embodiments described herein.

Various embodiments described herein provide for systems, methods, devices, instructions, and like for facilitating generation of a row embedding for a row of data table (e.g., of a database system). In particular, various embodiments provide for training and subsequent use of a transformer for generating row embeddings for one or more rows of a data table, where each of the one or more rows share the same plurality of fields (or cells). For instance, a self-supervised method described herein can be provided for training transformers on heterogeneous tabular data containing values for both numerical fields (or numerical cells) and categorical fields (or categorical cells). In another instance, a semi-supervised learning case can be provided. The resulting, trained transformer can encode rows into mathematical vector embeddings (or row embeddings), which can be clustered based on semantic meaning (e.g., rather than simple statistical properties). For example, the (trained) transformer can be used to generate row embedding to represent an individual row of a data table, and can generate the row embedding for the individual row such that a semantic notion of similarity of the individual row can be mathematically mapped to a geometric notion of similarity. This can be useful in various applications include, without limitations, similarity searching, row comparisons, detection of anomalous rows (e.g., unsupervised anomalous row detection, such as for data tables with a large number of rows), or using the row embeddings (e.g., as dense feature representations of rows) to enable other machine learning (ML)/deep learning (DL) techniques for downstream supervised tasks. Accordingly, use of various embodiments provides for improved deep learning techniques to learn representations of tabular data rows that accurately capture semantic similarity and dissimilarity of rows of data tables, which can be useful in various downstream applications (e.g., data analytics, machine learning tasks, etc.).

During training of the transformer on tabular training data, various embodiments use (e.g., a set of initial processing operations) to implement masked cell modeling for numerical values (or numerical features) of randomly-selected numerical fields of rows, replaced cell detection for categorical values (or categorical features) of randomly-selected categorical fields of rows, or both, prior to field values (or cell values) being passed to the feature tokenizer (e.g., of the FTT). For various embodiments, using different reconstruction objectives for training the transformer (e.g., replaced cell detection for categorical values/features and masked cell reconstruction for numerical values/features) facilitates parallelizable prediction layers (e.g., reconstruction heads), which in turn can reduce parameter footprint and accelerate training. When the (trained) transformer is used for an inference operation, a set of transformed output values (e.g., row embeddings generated for individual field values) generated by the transformer can be used to generate a single row embedding for an individual row by pooling (e.g., mean pooling) operation or process applied to the set of transform output values. For some embodiments, the set of embedding layers (to generate feature vectors or token vectors) and the set of prediction (or reconstruction) layers used are associated with an individual data table schema (e.g., different embedding layers and different prediction layers for tables with different field/column structures), while a common transformer (e.g., trained using rows from data tables having different schemas) is used for rows from data having different schemas. In this way, some embodiments described herein can pre-train on data tables with different schemas using specialized embedding layers and reconstruction heads for each different schema, but can pre-train and subsequently use a common transformer across data tables with different schemas.

For some embodiments, a transformer is trained to generate a row embedding for each of one or more rows of a data table, where each row comprises a plurality of fields (e.g., an age field, a weight field, a height field, an is_resident Boolean field, and a city field to store information for individuals in a data table), and where each field is capable of storing a field value for the row. The transformer can be trained by obtaining training data (e.g., tabular training data) that comprises a data table having a set of rows, where each row comprises a plurality of fields (or cells) storing a numerical value or a categorical value. For each individual row (of the set of rows) used to train the transformer, field values (or cell values) of the individual row are inputted into a feature tokenizer, and the output of the feature tokenizer is inputted into a transformer to generate a plurality of transformer output values for the individual row. For some embodiments, the feature tokenizer and the transformer form part of a feature tokenizer-transformer (FTT), which can be implemented as a shared transformer skeleton along with a set of initial processing operations and a set of prediction layers (e.g., reconstruction heads). During the training of the transformer (e.g., in a self-supervised manner), numerical values of a subset of numerical fields (or numerical cells) of inputted rows are randomly masked (e.g., using methods typical of masked language modeling), and the set of prediction layers are used to predict (e.g., reconstruct) the original numerical values of the respective numerical fields (including the masked numerical fields). Additionally, during the training of the transformer (e.g., in a self-supervised manner), categorical values of a subset of categorical fields (or category cells) of inputted rows are randomly replaced with another categorical value (e.g., another viable categorical value), and the set of prediction layers are used to predict whether categorical values of respective categorical fields (including the replaced categorical fields) were replaced (e.g., using a cross-entropy loss for binary classification). The transformer that results from a training process described herein can be used (e.g., during inference operations) to generate a row embedding for a given row of a data table that has a similar structure to the rows used during training (e.g., for rows that have the same fields).

For some embodiments, a (trained) transformer is used to perform an inference operation to generate (e.g., in an unsupervised manner) a row embedding for each of one or more rows of a data table, where each row comprises a plurality of fields (e.g., an age field, a weight field, a height field, an is_resident field, and a city field to store information for individuals in a data table), and where each field is capable of storing a field value for the row. Specifically, a new input row can be accessed from a data table for generation of a row embedding, where the new input row comprises a plurality of fields (that store one or more numerical values, categorical values, or both). A plurality of field values can be passed through a set of initial processing operations, which is configured to cause replacement of categorical values from one or more randomly-selected categorical fields with replacement values (e.g., randomly-selected categorical values) and to cause masking of numerical values from one or more randomly selected numerical fields. The plurality of intermediate field values generated by the set of input processing layers can be received by a feature tokenizer, which can generate a plurality of token vectors corresponding to the values of the plurality of intermediate field values. Thereafter, the plurality of token vectors can be received (e.g., as a sequence of token vectors) by the (trained) transformer, which can generate a plurality of transformer output values (e.g., output embeddings) based on plurality of token vectors. Subsequently, a pooling (e.g., mean pooling) operation or process can be applied to the plurality of transformer output values (e.g., output embeddings) to generate a single row embedding (e.g., dense vector embedding) for the new input row.

As used herein, a row forms part of a data table (e.g., of a database system), and each row can comprise one or more fields, where each field of a given row can store a field value (or value) for the given row. In this way, each row within a given data table can share the same structure of fields, while individually storing different field values within their respective fields. As used herein, a field can also be referred to as a cell of a row. A field (or cell) can store a value (e.g., field value or cell value). A field (or cell) of a row of a data table can correspond to a column of the data table. A value of a field (or cell) can be regarded as a feature, which can be received as input by a feature tokenizer. A numerical field of a row can store a numerical value for the row. A categorical field of a row can store a categorical value (e.g., text or numerical value) that is selected for the categorical field from a range of possible categorical values associated with the categorical field. An example of a categorical field can include, without limitation, a city field, a state field, a country field, a Boolean field (e.g., true or false field), a color field, or the like.

As used herein, an embedding (or embedding value) can refer to a numerical vector embedding (or vector embedding), which can comprise a numerical vector representation of an object (e.g., a row from a data table) and which can represent a semantic notion of similarity and dissimilarity between objects in a geometric space. A row embedding (or row embedding value) for a given row can refer to an embedding generated based on field values stored in the given row.

As used herein, a feature tokenizer (or tokenizer) can comprise a component or model that receives input data (e.g., a set of field values, cell values, or features) and produces a structured numerical representation (e.g., number or vector) corresponding to each individual component of the input data (e.g., field value, cell value, or feature). Taken together, the representations produced can serve as a more regularly structured representation of the input data, which can more easily be processed by a machine learning (ML) model, such as a transformer. As used herein, a set of embedding layers can implement feature tokenizer to generate feature vectors or token vectors.

As used herein, a transformer (or a transformer model) comprises a machine learning (ML) model that is a sequence-to-sequence model, which is configured to receive an input sequence of data (e.g., token vectors) of variable length and generate an output sequence of data (e.g., token vectors) of variable length based on the input sequence. A transformer can comprise a feedforward neural network, and can include a self-attention mechanism that allows the transformer to weigh the importance of different positions within the input sequence to better understand the relationships between elements in the sequence. For example, a transformer can comprise an encoder that transforms input sequence into a series of context-rich representations using multiple layers of self-attention and feed-forward neural networks, optionally with a decoder that generates an output sequence based on the encoder's representations and its own self-attention layers.

As used herein, a layer can comprise a layer of a machine learning (ML) model, such a layer of a neural network (e.g., a convolution layer of a convolution neural network). For various embodiments, each embedding layer and each prediction layer comprises a layer of an ML model.

As used herein, a pooling operation or process can comprise a technique used for reducing the dimensions (e.g., token dimensions) of data by applying an aggregation function, such as a mean, median, max, or weighted average function, over a group of adjacent values to produce a lower-dimensional output. For example, a mean pooling operation or process can reduce the dimensions of data (e.g., with respect to machine learning and deep learning) by taking the mean (average) of a group of adjacent values to aggregate information. A mean pooling operation or process can be used with an output of an ML model (e.g., transformer) of an embodiment described herein.

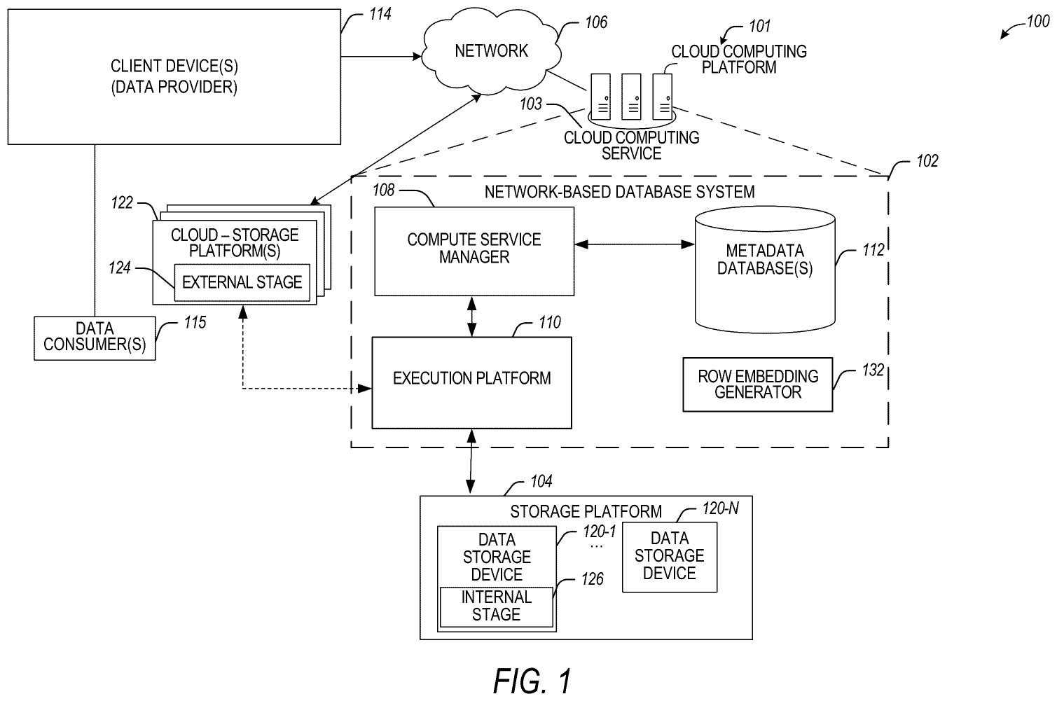

FIG. 1 illustrates an example computing environment 100 that includes a database system in the example form of a network-based database system 102, according to some embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some embodiments, the computing environment 100 may include a cloud computing platform 101 with the network-based database system 102, and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., configuring replication group objects as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage). The network-based database system 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services to multiple client accounts.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based database system 102. A user may utilize the client device 114 to submit data storage, retrieval, and analysis requests to the compute service manager 108. Client device 114 (also referred to as remote computing device or user device 114) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 101 (e.g., cloud computing service 103) by way of a network 106, such as the Internet or a private network. A data consumer 115 can use another computing device to access the data of the data provider (e.g., data obtained via the client device 114).

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some embodiments, metadata database 112 is configured to store account object metadata (e.g., account objects used in connection with a replication group object).

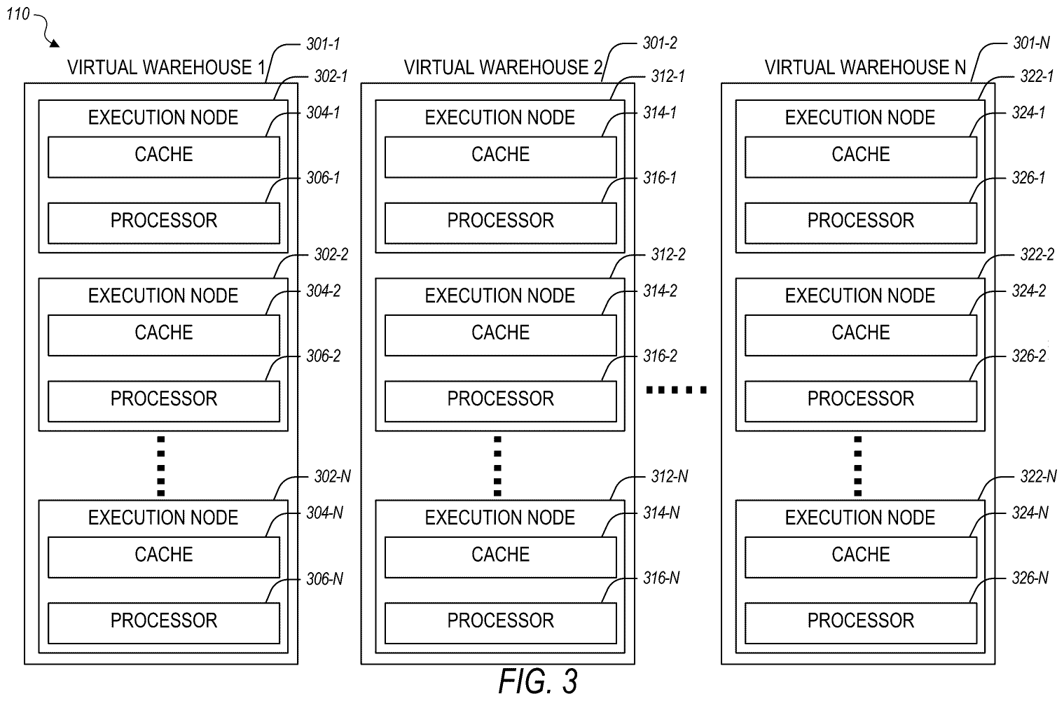

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

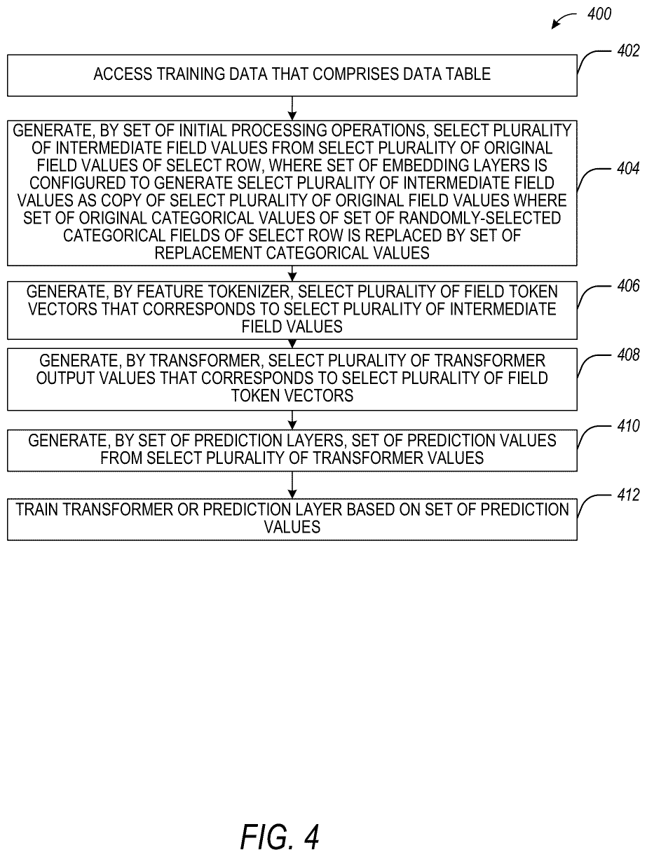

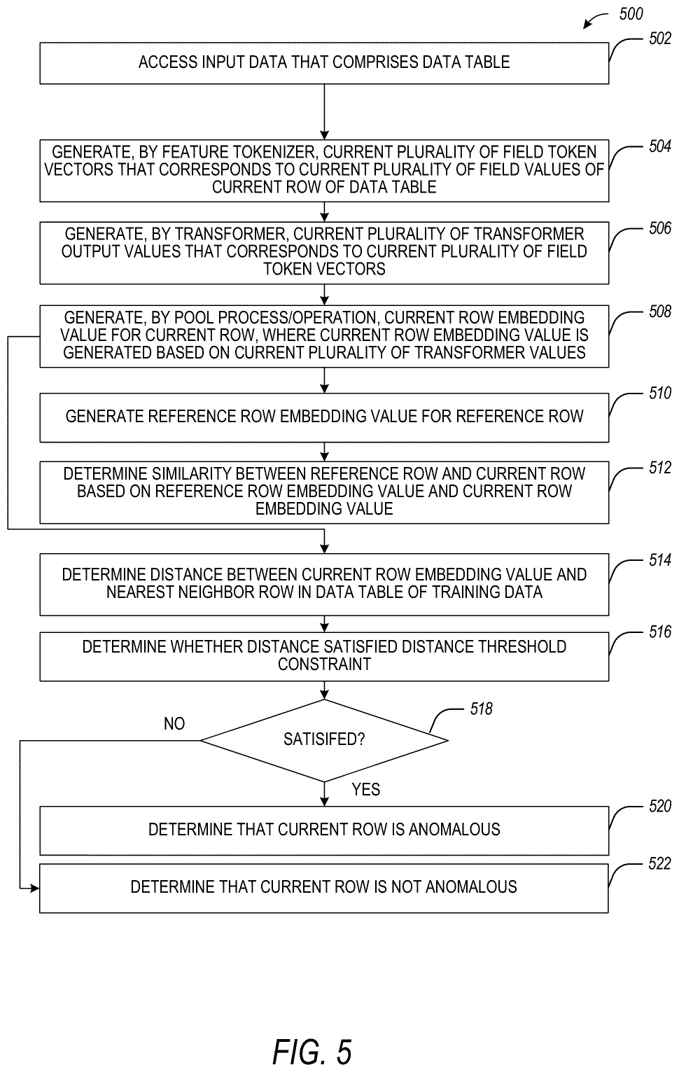

In some embodiments, the network-based database system 102 includes a row embedding generator 132. The row embedding generator 132 comprises suitable circuitry, interfaces, logic, and/or code and is configured to facilitate generation of row embedding from a row of a data table (e.g., of the network-based database system 102) according to various embodiments. In some embodiments, the row embedding generator 132 can include one or more system functions that can be used to implement a method for training a transformer in generating row embeddings and a method of using a transformer (e.g., during an inference operation) to generate a row embedding as described herein. More regarding example methods are described herein with respect to FIGS. 4 and 5.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

The compute service manager 108, metadata database(s) 112, execution platform 110, and storage platform 104, are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

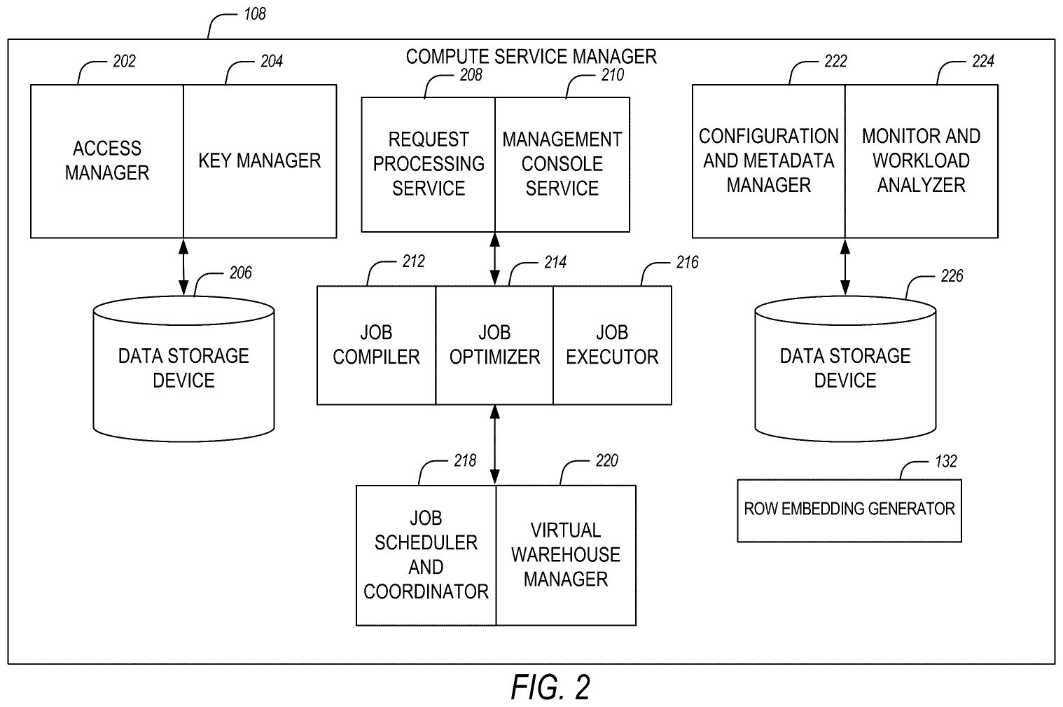

FIG. 2 is a block diagram illustrating components of the compute service manager 108, according to some embodiments. As shown in FIG. 2, the compute service manager 108 includes an access manager 202 and a key manager 204 coupled to an access metadata database 206, which is an example of the metadata database(s) 112. Access manager 202 handles authentication and authorization tasks for the systems described herein. The key manager 204 facilitates the use of remotely stored credentials to access external resources such as data resources in a remote storage device. As used herein, the remote storage devices may also be referred to as “persistent storage devices” or “shared storage devices.” For example, the key manager 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the key manager 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

As previously mentioned, the compute service manager 108 includes the row embedding generator 132 configured to facilitate generation of row embedding from a row of a data table according to various embodiments, which are further discussed herein with respect to least FIGS. 4 and 5.

FIG. 3 is a block diagram illustrating components of the execution platform 110, according to some embodiments. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues and network overhead). In some embodiments, the imbalances are addressed at the scan level using a file-stealing scheme. In particular, whenever a node process completes scanning its set of input files, it requests additional files from other nodes. If one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud storage platform 104 (e.g., from data storage device 120-1), and does not download the files from the transferring node. In this way, lagging nodes can transfer files via file stealing in a way that does not worsen the load on the lagging nodes.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

In some embodiments, table data can be divided into one or more micro-partitions, which are contiguous units of storage. As used herein, the terms “partition files” (or “partition data files”) and micro-partitions are interchangeable. In this regard, source table data can be stored as multiple partition files associated with the source table.

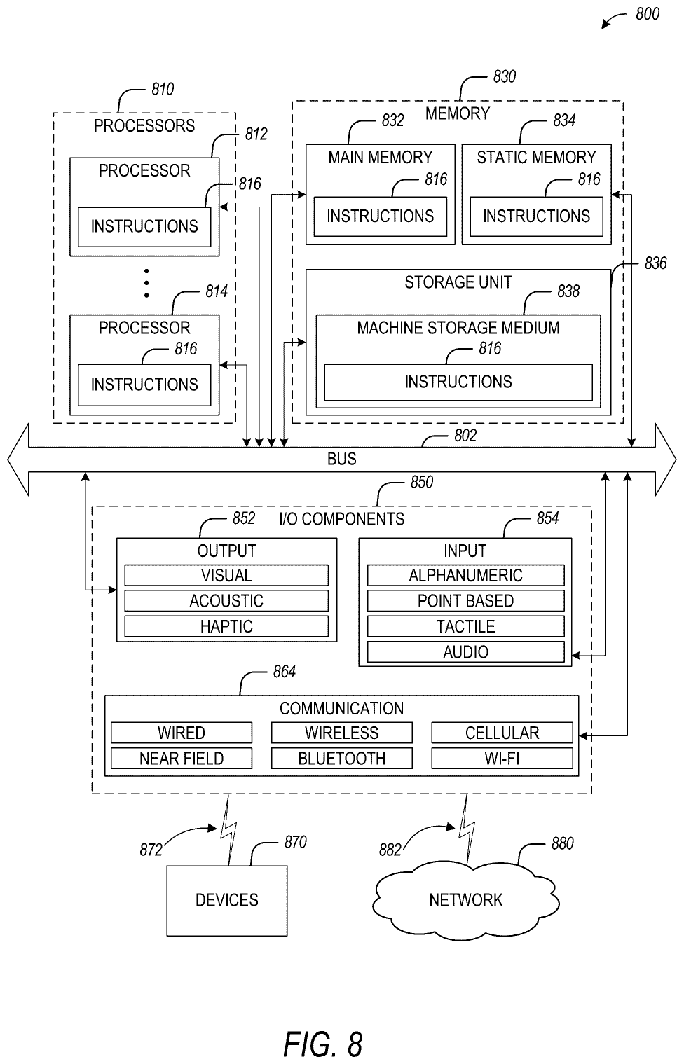

FIG. 4 is a flowchart of an example method 400 for training a transformer for generating a row embedding for a row of a data table, according to some embodiments. Method 400 may be embodied in computer-readable instructions for execution by one or more hardware components (e.g., one or more processors) such that the operations of method 400 can be performed by components of the network-based database system 102, such as a network node (e.g., the row embedding generator 132 executing on a network node of the compute service manager 108) or a computing device (e.g., client device 114), one or both of which may be implemented as machine 800 of FIG. 8 performing the disclosed functions. Accordingly, method 400 is described below, by way of example with reference thereto. However, it shall be appreciated that method 400 may be deployed on various other hardware configurations and is not intended to be limited to deployment within the network-based database system 102.

At operation 402, one or more hardware processors cause training data to be accessed, where the training data comprises a data table, where the data table comprises a set of rows that store data, and where each row of the set of rows comprises a plurality of fields (e.g., in accordance with a data table schema). The data table of the training data can be maintained or stored on a database system (e.g., 102) or a data platform. For various embodiments, the training data comprises one or more rows that store non-anomalous data. In this way, various embodiments enable the transformer to be trained for use with detecting anomalous rows in a data table.

For a select row of the set of rows (of the data table), at operation 404, one or more hardware processors causes a select plurality of intermediate field values to be generated by a set of initial processing operations, where the select plurality of intermediate field values is generated based on a select plurality of original field values of the select row, and where the select plurality of intermediate field values corresponds to the select plurality of original field values. For some embodiments, the same masking operation is for any numerical values. For some embodiments, replacement operation differs between different categorical fields (since the replacement categorical values are field-specific).

For various embodiments, the set of initial processing operations is configured to generate the select plurality of intermediate field values by receiving the select plurality of original field values from the select row, and replacing in the select plurality of intermediate field values, a set of original categorical values of a set of randomly-selected categorical fields (of the select row) with a set of replacement categorical values (as the select plurality of original field values passes through the set of initial processing operations). The replacement categorical value used for a given categorical field can be randomly selected from a range of possible categorical values associated with (e.g., applicable to) the given categorical field. According to various embodiments, the set of randomly-selected categorical fields of the select row represents only some (e.g., 15%) of the categorical fields of the select row that pass through the set of initial processing operations.

Additionally, for some embodiments, the set of initial processing operations is configured to generate the select plurality of intermediate field values by replacing in the select plurality of intermediate field values, a set of original numerical values of a set of randomly-selected numerical fields (of the select row) with a set of masked values (as the select plurality of original field values passes through the set of initial processing operations). According to various embodiments, the set of randomly-selected numerical fields of the select row represents only some (e.g., 15%) of the numerical fields of the select row that pass through the set of initial processing operations. Further, the set of initial processing operations can be configured to apply normalization (e.g., using z-score transformation) of one or more numerical values (of numerical fields) that pass through the set of initial processing operations. For some embodiments, the set of initial processing operations is configured for specific use with rows from data tables having a specific schema (e.g., a schema similar to that of the data table of the training data).

At operation 406, one or more hardware processors causes a select plurality of field token vectors to be generated by a feature tokenizer, where the select plurality of field token vectors is generated based on a select plurality of intermediate field values (generated by operation 404), and where the select plurality of field token vectors corresponds to the select plurality of intermediate field values. Operation 406 causes an individual field token vector to be generated for each individual field value from the select row. For some embodiments, the select plurality of field token vectors are fed into the transformer as a sequence of token vectors (e.g., with the sequence starting with a single classification (CLS) token). For some embodiments, different feature tokenizers are used for different fields.

At operation 408, one or more hardware processors causes a select plurality of transformer output values (e.g., output embeddings) to be generated by a transformer, where the select plurality of transformer output values is generated based on the select plurality of field token vectors (generated by operation 406), and where the select plurality of transformer output values corresponds to the select plurality of field token vectors. Each transformer output value (of the select plurality of transformer output values) can represent an embedding value for a corresponding field value from the select row. For some embodiments, the feature tokenizer and the transformer form part of an FTT.

At operation 410, one or more hardware processors causes a set of prediction values to be generated by a set of prediction layers (e.g., reconstruction heads), where the set of prediction values is generated based on the select plurality of transformer output values (generated by operation 408), and where the set of prediction values corresponds to the select plurality of transformer output values. The set of prediction layers can represent a group of convolution operations performed on the select plurality of transformer output values. For some embodiments, the set of prediction layer includes a (single common) prediction layer for processing any transformer output value (e.g., output embedding) that correspond to a numerical value, and a different prediction layer for each of different categorical fields providing categorical values from the select row. For various embodiments, a prediction layer for processing transformer output values (e.g., output embeddings) corresponding to a numerical field of the select row (that is providing numerical values) is configured to predict (or reconstruct) the original numerical value that was obtained from the numerical field and subsequently processed by the set of initial processing operations. Additionally, for various embodiments, a prediction layer for processing transformer output values (e.g., output embeddings) corresponding to a categorical field of the select row (that is providing categorical values) is configured to predict (or detect) whether the original numerical value that was obtained from the categorical field was replaced (with a random-selected replacement categorical value) by the set of initial processing operations.

For a prediction value in the set of prediction values that corresponds to a numerical field of the select row, the prediction value can represent the original numerical value of the numerical field as predicted by the set of prediction layers (based on a corresponding transformer output value received from the transformer). For a prediction value in the set of prediction values that corresponds to a categorical field of the select row, the prediction value can comprise a zero-to-one-valued prediction or score (e.g., generated by a replaced cell detection method) that indicates a predicted probability that the categorical value was replaced (e.g., an original categorical value of the randomly-selected categorical field was replaced). For some embodiments, the set of prediction layers is configured for specific use with rows from data tables having a specific schema (e.g., a schema similar to that of the data table of the training data).

At operation 412, one or more hardware processors causes the transformer, the set of prediction layers, or both to be trained based on the set of prediction values (generated by the operation 410) and a set of expected values (e.g., ground truths), where operation 412 comprises adjusting one or more parameters (e.g., weights) of the transformer, the set of prediction layers, or both based on the set of prediction values (e.g., which can a probability that a categorical value was replaced. A set of expected values used by operation 412 can be captured/generated when the intermediate field values are generated by the set of initial processing operations. For some embodiments, with respect to categorical values from categorical fields of the select row, adjusting the one or more parameters based on the set of prediction values can comprise comparing a prediction value (generated by the set of prediction layers) to an expected value for the categorical field, where the expected value indicates whether an original categorical value of the categorical field was actually replaced, and the select prediction value represents a probability that a replacement happened. For instance, with respect to a randomly-selected categorical field that has its original categorical value replaced (by the set of initial processing operations), the expected value can indicate that the original categorical value was replaced, and the select prediction value can indicate the confidence of a replacement event assigned by the set of prediction layers. If the comparison determines there is a mismatch between the expected value and the predicted value, one or more parameters (e.g., weights) of the transformer can be adjusted. For example, an embodiment can use backpropagation through a Binary cross-entropy loss (BC E) (as a loss measurement) to facilitate the adjustment by gradient-based optimization of the one or more parameters based on the expected values and the predicted values associated with a categorical value from a categorical field of the select row.

For some embodiments, with respect to numerical values from numerical fields of the select row, adjusting the one or more parameters based on the set of prediction values can comprise comparing a prediction value (generated by the set of prediction layers) to an expected value for the numerical field, where the expected value is the original numerical value obtained from the numerical field, and the prediction value is supposed to be a reconstruction of the original numerical value based on the transformer output value (e.g., output embedding) corresponding to the numerical field. For instance, with respect to a randomly-selected numerical field that has its original numerical value masked (by the set of initial processing operations), the expected value can be the original numerical value before it was masked, and the prediction value generated by the set of prediction layers should match the expected value/original numerical value. If the comparison determines there is a mismatch between the expected value and the predicted value, one or more parameters (e.g., weights) of the transformer, the set of prediction layers, or both can be adjusted. For example, an embodiment can use Mean Squared Error (MSE) (as a loss measurement) to facilitate the adjustment of the one or more parameters based on the expected values and the predicted values associated with a numerical value from a numerical field of the select row.

For various embodiments, method 400 can be used to train a transformer using two or more tables having different structures/schemas, which can facilitate (e.g., massive or scaled) multi-table pre-training of the transformer. This is possible given that, for some embodiments, the transformer can be commonly used for tables of different structures/schemas, while different sets of embedding layers (implementing a feature tokenizer) and prediction layers are used for each different table structure/schema. In other words, given that different tables have different field features and distributions, for some embodiments, only the initial set of embedding layers (implementing a feature tokenizer) and final set of prediction layers during training are learned specifically for a given table structure/schema, thereby enabling the for massive pre-training of the (middle) transformer (e.g., FTT). For instance, the methodology can comprise performing the following (e.g., on a single computing machine): sample a data table (e.g., from a plurality of data tables provided as training data) randomly and select a batch of rows from that data table; restore the state of the specialized parts of the model (including the optimizer) from the last time this data table was used in a training batch while keeping the transformer the same; and run training over the batch of rows.

FIG. 5 is a flowchart of example method 500 for using a transformer to generate a row embedding for a row of a data table, according to some embodiments. For some embodiments, the transformer used by one or more operations of method 500 is trained by way of method 400 of FIG. 4. Method 500 may be embodied in computer-readable instructions for execution by one or more hardware components (e.g., one or more processors) such that the operations of method 500 can be performed by components of the network-based database system 102, such as a network node (e.g., the row embedding generator 132 executing on a network node of the compute service manager 108) or a computing device (e.g., client device 114), one or both of which may be implemented as machine 800 of FIG. 8 performing the disclosed functions. Accordingly, method 500 is described below, by way of example with reference thereto. However, it shall be appreciated that method 500 may be deployed on various other hardware configurations and is not intended to be limited to deployment within the network-based database system 102.

At operation 502, one or more hardware processors causes input data to be accessed, where the input data comprises a data table, and where the data table comprises a set of rows that store data, and where each row of the set of rows comprises a plurality of fields. During operation 502, a set of ground truth (or expected) values or labels is generated or captured for those numerical values being masked and categorical values that are being replaced by operation 502. For various embodiments, the set of rows represent one or more new input rows for which row embeddings are to be generated using the trained transformer. Additionally, for some embodiments, the plurality of fields and the schema of the data table are the same as those of the data table of the training data (e.g., used by method 400 of FIG. 4) used to train the transformer. As described herein, a trained transformer of some embodiments can be used with respect to rows from data tables having different structures/schemas, while the set of initial processing operations and the set of prediction layers are configured for use with data tables having a specific table structure/schema. The data table of the input data can be maintained or stored on a database system (e.g., 102) or a data platform.

At operation 504, one or more hardware processors causes a current plurality of field token vectors to be generated by a feature tokenizer, where the current plurality of field token vectors is generated based on a current plurality of field values, and where the current plurality of field token vectors corresponds to the select plurality of field values. Operation 504 causes an individual field token vector to be generated for each individual field value from the current row. For some embodiments, the current plurality of field token vectors is fed into the transformer as a sequence of token vectors (e.g., with the sequence starting with a single classification (CLS) token). For various embodiments, the feature tokenizer used during operation 504 is the same as the feature tokenizer used (e.g., by method 400 of FIG. 4) during the training of the transformer.

At operation 506, one or more hardware processors causes a current plurality of transformer output values (e.g., output embeddings) to be generated by a transformer, where the current plurality of transformer output values is generated based on the current plurality of field token vectors (generated by operation 504), and where the current plurality of transformer output values corresponds to the current plurality of field token vectors. Each transformer output value (of the current plurality of transformer output values) can represent an embedding value for a corresponding field value from the current row. For some embodiments, the feature tokenizer and the transformer form part of a FTT, where the FTT is the same FTT used by method 400 of FIG. 4.

At operation 508, one or more hardware processors causes a current row embedding value for the current row to be generated by a pooling (e.g., mean pool) operation or process, where the current row embedding value is generated based on the current plurality of transformer output values (generated by operation 506). For various embodiments, operations 504, 504, 506, and 508 represent performance of an inference operation for generating a row embedding for an input row. After operation 508, method 500 can continue to operation 510, to operation 514, or to both (e.g., in parallel). For instance, method 500 can proceed to operation 510 to compare the similarity (or dissimilarity) of the current row to a reference row (from the same data table, or another data table having the same table structure/schema). Additionally, or alternatively, the method 500 can proceed to operation 514 to determine whether the current row is an anomalous row.

At operation 510, one or more hardware processors causes a reference row embedding value to be generated for the reference row. For various embodiments, the reference row embedding value is generated in a manner similar to the current row embedding value generated for the current row, using the set of initial processing operations, the feature tokenizer, the transformer, and the mean pool operation/process. Depending on the embodiment, the reference row can be obtained from the same data table that provided the current row, or can be obtained from another data table that has a similar table structure/schema as the data table that provided the current row (e.g., data table of the training data). Thereafter, at operation 512, one or more hardware processors determines a similarity (e.g., a degree of similarity or dissimilarity) between the reference row and the current row based on the reference row embedding value (generated by operation 510) and the current row embedding value (generated by operation 508). For instance, the lower the distance (e.g., cosine distance) between the reference row embedding and the current row embedding, the more similar the reference row and the current row are.

Operations 514 through 522 can identify the current row as an anomaly when the current row is dissimilar to (e.g., all) non-anomalous rows (e.g., such as those used in the training data by method 400 of FIG. 4). At operation 514, one or more hardware processors determines a distance (e.g., cosine distance) between the current row embedding value and a nearest neighbor row embedding value corresponding to the data in the data table of the training data (e.g., used by method 400 of FIG. 4 to train the transformer). For some embodiments, the nearest neighbor is searched by distance to the embeddings of all the rows of the data table of the training data (e.g., where row embedding values are generated for some or all of the rows of the data table to compare against). For instance, the rows used from the training data are a carefully selected subset of the rows. At operation 516, one or more hardware processors determine whether the distance satisfies a distance threshold constraint. For example, the one or more hardware processors can determine whether the distance surpasses (e.g., is greater than) a distance threshold (or distance threshold value) defined by the distance threshold constraint. Various embodiments can use different distance threshold constraints, and a given distance threshold constraint can comprise multiple different distance thresholds. Depending on the embodiment, the distance threshold can comprise a value determined (e.g., defined) by a user or determined by some process (e.g., automatic process). For various embodiments, a distance threshold of a distance threshold constraint determines a sensitivity level in detecting anomalous rows within a data table (e.g., the lower the distance threshold, the more sensitive the anomalous row detection is). Subsequently, at decision point 518, the method 500 proceeds to operation 520 in response to the distance satisfying the distance threshold constraint (e.g., the distance surpassing a distance threshold of the distance threshold constraint), and the method 500 proceeds to operation 522 in response to the distance not satisfying the distance threshold constraint (e.g., distance not surpassing a distance threshold of the distance threshold constraint). At operation 520, one or more hardware processors determines that the current row is anomalous and, at operation 522, one or more hardware processors determines that the current row is not anomalous.

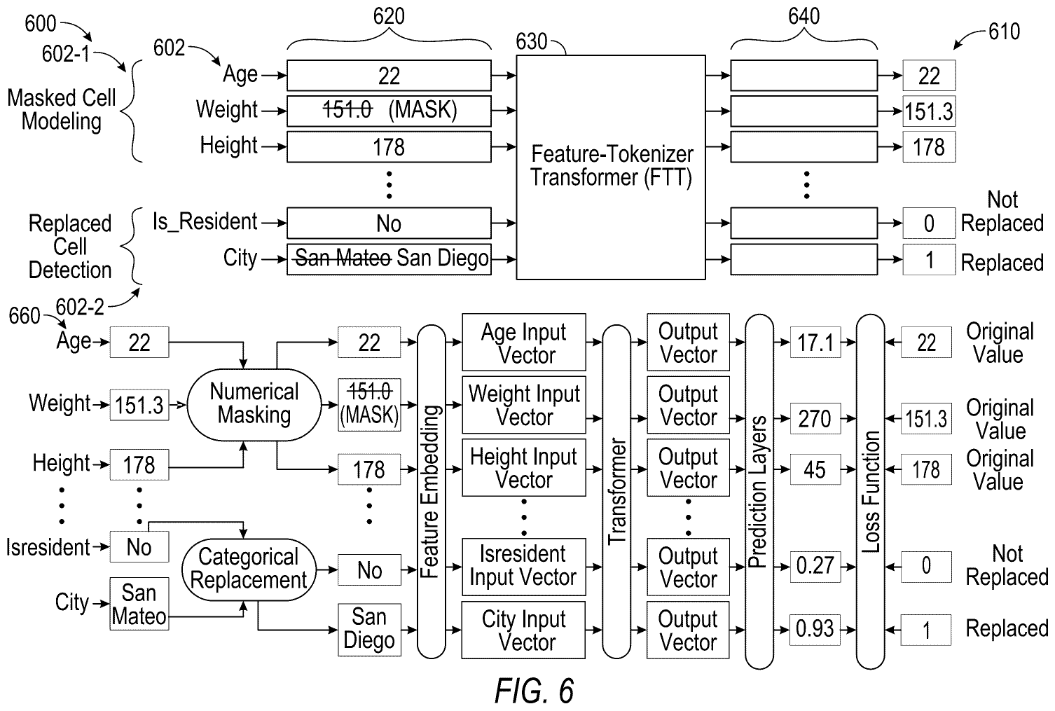

FIG. 6 is a diagram of an example row embedding generator 600 during training for generation of row embeddings for rows from a data table, according to some embodiments. In FIG. 6, the row embedding generator 600 comprises a set of initial processing operations 620 (e.g., specialized initial processing operations), a feature-tokenizer transformer (FTT) 630, and a set of prediction layers 640. As shown, during training operation, an individual row is accessed from a data table (e.g., stored as training data), where the individual row comprises the following fields 602: an age numerical field; a weight numerical field; and a height numerical field; a is_resident categorical field (e.g., which stores a Boolean to indicate whether an individual associated with the individual row is a resident); and a city categorical field. The numerical values obtained from the age numerical field, the weight numerical field of the individual row, and the categorical values obtained from the is_resident categorical field and the city categorical field of the individual row, are received and processed by the set of initial processing operations 620.

The set of initial processing operations 620 is configured to apply masking to values corresponding to a set of randomly-selected numerical fields (selected from all numerical fields of the individual row 602-1), and is configured to replace original categorical values of a set of randomly-selected categorical fields (selected from all categorical fields of the individual row 602-2) with replacement categorical values (e.g., which are randomly selected from a range of categorical values applicable to the categorical field). For instance, as shown in FIG. 6, the set of initial processing operations 620 causes the numerical value (151.0) obtained from the weight numerical field of the individual row to be masked, and causes the categorical value (“San Mateo”) obtained from the city categorical field of the individual row to be replaced with “San Diego.” For some embodiments, the set of initial processing operations 620 is configured to apply masking to the numerical values of a certain portion or percentage of all numerical fields of the individual row, and to replace categorical values of a certain portion or percentage of all categorical fields of the individual row. For instance, the set of initial processing operations 620 can be configured to apply masking to the numerical values of 15% of all numerical fields of the individual row, and to replace categorical values of 15% of all categorical fields of the individual row. The portions/percentages can be determined or defined by a user. Additionally, the set of initial processing operations 620 can be configured to apply normalization (e.g., using z-score transformation) to all numerical values that are not masked.

The FTT 630 receives the field values of the individual row from the set of initial processing operations 620 and generates a transformer output vector (i.e., output embedding) for each field value, thereby transforming each input vector received into a transformer output vector. The transformer output vectors generated by the FTT 630 are subsequently processed by the set of prediction layers 640 to generate prediction values 610 (one prediction value corresponding to each transformer output vector). The set of prediction layers 640 is configured to predict (or reconstruct) an original numerical value of each numerical field (based on its corresponding transformer output value), and is configured to predict whether a categorical value of a categorical field was replaced by the set of initial processing operations 620 (predict based on the transformer output value corresponding to the categorical field). The prediction values are compared against the actual or expected values, and the difference (or loss) between the two values can be used to adjust one or more parameters (e.g., weights) of the transformer and/or prediction layers of the FTT 630 as described herein.

Diagram 660 illustrates a more detailed breakdown of components and data flow of the example row embedding generator 600 (during training for generation of row embeddings) in accordance with various embodiments.

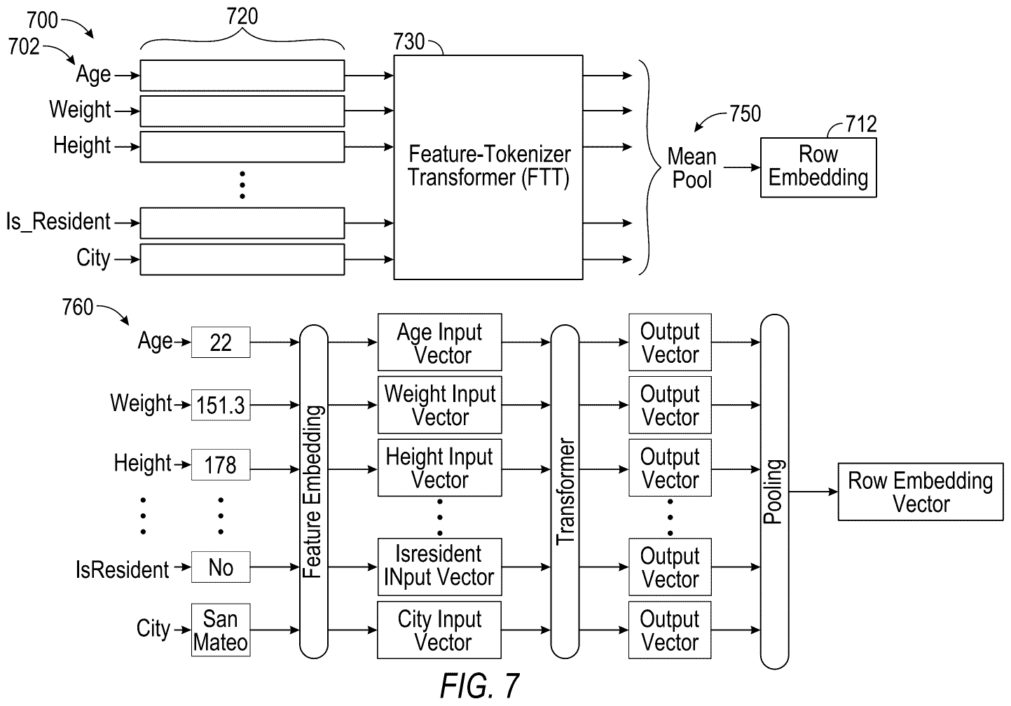

FIG. 7 is a diagram of an example row embedding generator 700 during generation of a row embedding for a row of a data table, according to some embodiments. In FIG. 7, the row embedding generator 700 comprises a set of initial processing operations 720 (e.g., specialized initial processing operations), and a feature-tokenizer transformer (FTT) 730. For various embodiments, the set of initial processing operations 720 is the same set of initial processing operations 620 of FIG. 6, and the FTT 730 is the same FTT 630 of FIG. 6.

As shown, during generation of a row embedding for an individual row, an individual row is accessed from a data table (e.g., stored as input data), where the individual row comprises the following fields 702: an age numerical field; a weight numerical field; and a height numerical field; a is_resident categorical field (e.g., which stores a Boolean to indicate whether an individual associated with the individual row is a resident); and a city categorical field. The numerical values obtained from the age numerical field, the weight numerical field of the individual row, and the categorical values obtained from the is_resident categorical field and the city categorical field of the individual row, are received and processed by the set of initial processing operations 720.

The plurality of field values produced by the set of initial processing operations 720 is received by the FTT 730, which generates a transformer output vector (i.e., output embedding) for each input vector, thereby transforming each input vector received into a transformer output vector. Subsequently, a mean pool (750) operation or process is applied to the plurality of transformer output vectors (i.e., output embeddings corresponding to the plurality of field values) generated by the FTT 730, which generates a single row embedding 712 for the individual row.

Diagram 760 illustrates a more detailed breakdown of components and data flow of the example row embedding generator 700 (during generation of a row embedding) in accordance with various embodiments.

FIG. 8 illustrates a diagrammatic representation of machine 800 in the form of a computer system within which a set of instructions may be executed for causing machine 800 to perform any one or more of the methodologies discussed herein, according to an embodiment. Specifically, FIG. 8 shows a diagrammatic representation of machine 800 in the example form of a computer system, within which instructions 816 (e.g., software, a program, an application, an applet, an app, or other executable code) for causing the machine 800 to perform any one or more of the methodologies discussed herein may be executed. For example, instructions 816 may cause machine 800 to execute any one or more operations of method 400 (or any other technique discussed herein). As another example, instructions 816 may cause machine 800 to implement one or more portions of the functionalities discussed herein. In this way, instructions 816 may transform a general, non-programmed machine into a particular machine 800 (e.g., the client device 114, the compute service manager 108, or a node in the execution platform 110) that is specially configured to carry out any one of the described and illustrated functions in the manner described herein. In yet another embodiment, instructions 816 may configure the client device 114, the compute service manager 108, and/or a node in the execution platform 110 to carry out any one of the described and illustrated functions in the manner described herein, which functions can be configured or performed by the row embedding generator 132.

In alternative embodiments, the machine 800 operates as a standalone device or may be coupled (e.g., networked) to other machines. In a networked deployment, machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

Machine 800 includes processors 810, memory 830, and input/output (I/O) components 850 configured to communicate with each other such as via a bus 802. In some embodiments, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 stores the instructions 816 embodying any one or more of the methodologies or functions described herein. The instructions 816 may also reside, completely or partially, within the main memory 832, within the static memory 834, within machine storage medium 838 of the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, communication components 864 may include a network interface component or another suitable device to interface with network 880. In further examples, communication components 864 may include wired communication components, wireless communication components, cellular communication components, and other communication components to provide communication via other modalities. The device 870 may be another machine or any of a wide variety of peripheral devices (e.g., a peripheral device coupled via a universal serial bus (USB)). For example, as noted above, machine 800 may correspond to any one of the client devices 114, the compute service manager 108, or the execution platform 110, and device 870 may include the client device 114 or any other computing device described herein as being in communication with the network-based database system 102 or the cloud storage platform 104.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 880 or a portion of network 880 may include a wireless or cellular network, and coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of several well-known transfer protocols (e.g., hypertext transfer protocol (HTTP)). Similarly, instructions 816 may be transmitted or received using a transmission medium via coupling 872 (e.g., a peer-to-peer coupling or another type of wired or wireless network coupling) to device 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: accessing training data that comprises a data table, the data table comprising a set of rows that store data, each row of the set of rows comprises a plurality of fields; and for a select row of the set of rows: generating, by a set of initial processing operations, a select plurality of intermediate field values based on a select plurality of original field values of the select row, the set of initial processing operations being configured to generate the select plurality of intermediate field values by replacing a set of original categorical values of a set of randomly-selected categorical fields of the select row in the select plurality of intermediate field values with a set of replacement categorical values; generating, by a feature tokenizer, a select plurality of field token vectors based on a select plurality of intermediate field values; generating, by a transformer, a select plurality of transformer output values based on the select plurality of field token vectors; generating, by a set of prediction layers, a set of prediction values based on the select plurality of transformer output values; and training the transformer or the set of prediction layers based on the set of prediction values by adjusting one or more parameters of at least one of the transformers or the set of prediction layers based on the set of prediction values.

In Example 2, the subject matter of Example 1 includes, wherein a select prediction value in the set of prediction values corresponds to a randomly-selected categorical field of the set of randomly-selected categorical fields, the select prediction value indicating whether an original categorical value of the randomly-selected categorical field was replaced.

In Example 3, the subject matter of Example 2 includes, wherein the adjusting of the one or more parameters based on the set of prediction values comprises: comparing the select prediction value to an expected value for the randomly-selected categorical field, the expected value indicating that an original categorical value of the randomly-selected categorical field was replaced; and adjusting the one or more parameters based on the comparing of the select prediction value to the expected value.

In Example 4, the subject matter of Examples 1-3 includes, wherein the set of initial processing operations is configured to generate the select plurality of intermediate field values by replacing, in the select plurality of intermediate field values, a set of original numerical values of a set of randomly-selected numerical fields of the select row with a set of masked values.

In Example 5, the subject matter of Example 4 includes, wherein the set of prediction values comprises a given prediction value corresponding to a randomly-selected numerical field of the set of randomly-selected numerical fields, and wherein the adjusting of the one or more parameters based on the set of prediction values comprises: comparing the given prediction value to an original numerical value of the randomly-selected numerical field; and adjusting the one or more parameters based on the comparing of the select prediction value to the original numerical value.

In Example 6, the subject matter of Examples 1-5 includes, wherein the feature tokenizer and the transformer are part of a feature-tokenizer transformer (FTT).

In Example 7, the subject matter of Examples 1-6 includes, wherein the data table is a first data table, and wherein the operations comprise: after the training of the transformer based on the set of prediction values, performing an inference operation using the transformer, the inference operation comprising: accessing input data that comprises a second data table, the second data table comprising a current row, the current row comprising the plurality of fields; generating, by the feature tokenizer, a current plurality of field token vectors that corresponds to a current plurality of original field values of the current row; generating, by the transformer, a current plurality of transformer output values that corresponds to the current plurality of field token vectors; and generating, by a mean pool operation, a current row embedding value for the current row, the current row embedding value being generated based on the current plurality of transformer output values.

In Example 8, the subject matter of Example 7 includes, wherein the second data table comprises a reference row, wherein the reference row comprises the plurality of fields, and wherein the operations comprise: after the performing of the inference operation: generating a reference row embedding value for the reference row; and determining a similarity between the reference row and the current row based on the reference row embedding value and the current row embedding value.

In Example 9, the subject matter of Example 8 includes, wherein the generating of the reference row embedding value for the reference row comprises: generating, by the set of initial processing operations, a reference plurality of intermediate field values based on a reference plurality of original field values of the reference row; generating, by the feature tokenizer, a reference plurality of field token vectors that corresponds to the reference plurality of intermediate field values; generating, by the transformer, a reference plurality of transformer output values that corresponds to the reference plurality of field token vectors; and generating, by a mean pool operation, the reference row embedding value for the reference row, the reference row embedding value being generated based on the reference plurality of transformer output values.

In Example 10, the subject matter of Examples 7-9 includes, wherein the operations comprise: after the performing of the inference operation: determining a distance between the current row embedding value and a nearest neighbor row in the first data table of the training data; determining whether the distance satisfies a distance threshold constraint; and determining that the current row is anomalous in response to determining that the distance satisfies the distance threshold constraint.

In Example 11, the subject matter of Examples 7-10 includes, wherein the operations comprise: after the performing of the inference operation: determining a distance between the current row embedding value and a nearest neighbor row in the first data table of the training data; determining whether the distance satisfies a distance threshold constraint; and determining that the current row is not anomalous in response to determining that the distance does not satisfy the distance threshold constraint.

Example 12 is a method to implement any of Examples 1-11.

Example 13 is a machine-storage medium, the machine-storage medium including instructions that when executed by a machine, cause the machine to perform operations to implement any of Examples 1-11.

Various embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
accessing training data that comprises a data table, the data table comprising a set of rows that store data, each row of the set of rows comprises a plurality of fields; and
for a select row of the set of rows:
generating, by a set of initial processing operations, a select plurality of intermediate field values based on a select plurality of original field values of the select row, the set of initial processing operations being configured to generate the select plurality of intermediate field values by replacing a set of original categorical values of a set of randomly-selected categorical fields of the select row in the select plurality of intermediate field values with a set of replacement categorical values;
generating, by a feature tokenizer, a select plurality of field token vectors based on a select plurality of intermediate field values;
generating, by a transformer, a select plurality of transformer output values based on the select plurality of field token vectors;
generating, by a set of prediction layers, a set of prediction values based on the select plurality of transformer output values; and
training the transformer or the set of prediction layers based on the set of prediction values by adjusting one or more parameters of at least one of the transformers or the set of prediction layers based on the set of prediction values.

2. The system of claim 1, wherein a select prediction value in the set of prediction values corresponds to a randomly-selected categorical field of the set of randomly-selected categorical fields, the select prediction value indicating whether an original categorical value of the randomly-selected categorical field was replaced.

3. The system of claim 2, wherein the adjusting of the one or more parameters based on the set of prediction values comprises:
comparing the select prediction value to an expected value for the randomly-selected categorical field, the expected value indicating that an original categorical value of the randomly-selected categorical field was replaced; and
adjusting the one or more parameters based on the comparing of the select prediction value to the expected value.

4. The system of claim 1, wherein the set of initial processing operations is configured to generate the select plurality of intermediate field values by replacing, in the select plurality of intermediate field values, a set of original numerical values of a set of randomly-selected numerical fields of the select row with a set of masked values.

5. The system of claim 4, wherein the set of prediction values comprises a given prediction value corresponding to a randomly-selected numerical field of the set of randomly-selected numerical fields, and wherein the adjusting of the one or more parameters based on the set of prediction values comprises:
comparing the given prediction value to an original numerical value of the randomly-selected numerical field; and
adjusting the one or more parameters based on the comparing of the select prediction value to the original numerical value.

6. The system of claim 1, wherein the feature tokenizer and the transformer are part of a feature-tokenizer transformer (FTT).

7. The system of claim 1, wherein the data table is a first data table, and wherein the operations comprise:
after the training of the transformer based on the set of prediction values, performing an inference operation using the transformer, the inference operation comprising:
accessing input data that comprises a second data table, the second data table comprising a current row, the current row comprising the plurality of fields;
generating, by the feature tokenizer, a current plurality of field token vectors that corresponds to a current plurality of original field values of the current row;
generating, by the transformer, a current plurality of transformer output values that corresponds to the current plurality of field token vectors; and
generating, by a mean pool operation, a current row embedding value for the current row, the current row embedding value being generated based on the current plurality of transformer output values.

8. The system of claim 7, wherein the second data table comprises a reference row, wherein the reference row comprises the plurality of fields, and wherein the operations comprise:
after the performing of the inference operation:
generating a reference row embedding value for the reference row; and
determining a similarity between the reference row and the current row based on the reference row embedding value and the current row embedding value.

9. The system of claim 8, wherein the generating of the reference row embedding value for the reference row comprises:
generating, by the set of initial processing operations, a reference plurality of intermediate field values based on a reference plurality of original field values of the reference row;
generating, by the feature tokenizer, a reference plurality of field token vectors that corresponds to the reference plurality of intermediate field values;
generating, by the transformer, a reference plurality of transformer output values that corresponds to the reference plurality of field token vectors; and
generating, by a mean pool operation, the reference row embedding value for the reference row, the reference row embedding value being generated based on the reference plurality of transformer output values.

10. The system of claim 7, wherein the operations comprise:
after the performing of the inference operation:
determining a distance between the current row embedding value and a nearest neighbor row in the first data table of the training data;
determining whether the distance satisfies a distance threshold constraint; and
determining that the current row is anomalous in response to determining that the distance satisfies the distance threshold constraint.

11. The system of claim 7, wherein the operations comprise:
after the performing of the inference operation:
determining a distance between the current row embedding value and a nearest neighbor row in the first data table of the training data;
determining whether the distance satisfies a distance threshold constraint; and
determining that the current row is not anomalous in response to determining that the distance does not satisfy the distance threshold constraint.

12. A method comprising:
accessing, by one or more hardware processors, training data that comprises a data table, the data table comprising a set of rows that store data, each row of the set of rows comprises a plurality of fields; and
for a select row of the set of rows:
generating, by a set of initial processing operations, a select plurality of intermediate field values based on a select plurality of original field values of the select row, the set of initial processing operations being configured to generate the select plurality of intermediate field values by replacing a set of original categorical values of a set of randomly-selected categorical fields of the select row in the select plurality of intermediate field values with a set of replacement categorical values;
generating, by a feature tokenizer, a select plurality of field token vectors based on a select plurality of intermediate field values;
generating, by a transformer, a select plurality of transformer output values based on the select plurality of field token vectors;
generating, by a set of prediction layers, a set of prediction values based on the select plurality of transformer output values, a select prediction value in the set of prediction values corresponding to a randomly-selected categorical field of the set of randomly-selected categorical fields, the select prediction value indicating whether an original categorical value of the randomly-selected categorical field was replaced; and
training, by the one or more hardware processors, the transformer or the set of prediction layers based on the set of prediction values by adjusting one or more parameters of at least one of the transformer or the set of prediction layers based on the set of prediction values.

13. The method of claim 12, wherein a select prediction value in the set of prediction values corresponds to a randomly-selected categorical field of the set of randomly-selected categorical fields, the select prediction value indicating whether an original categorical value of the randomly-selected categorical field was replaced.

14. The method of claim 13, wherein the adjusting of the one or more parameters based on the set of prediction values comprises:
comparing the select prediction value to an expected value for the randomly-selected categorical field, the expected value indicating that an original categorical value of the randomly-selected categorical field was replaced; and
adjusting the one or more parameters based on the comparing of the select prediction value to the expected value.

15. The method of claim 12, wherein the set of initial processing operations is configured to generate the select plurality of intermediate field values by replacing, in the select plurality of intermediate field values, a set of original numerical values of a set of randomly-selected numerical fields of the select row with a set of masked values.

16. The method of claim 15, wherein the set of prediction values comprises a given prediction value corresponding to a randomly-selected numerical field of the set of randomly-selected numerical fields, and wherein the adjusting of the one or more parameters based on the set of prediction values comprises:
comparing the given prediction value to an original numerical value of the randomly-selected numerical field; and
adjusting the one or more parameters based on the comparing of the select prediction value to the original numerical value.

17. The method of claim 12, wherein the feature tokenizer and the transformer are part of a feature-tokenizer transformer (FTT).

18. The method of claim 12, wherein the data table is a first data table, and wherein the method comprises:
after the training of the transformer based on the set of prediction values, performing an inference operation using the transformer, the inference operation comprising:
accessing input data that comprises a second data table, the second data table comprising a current row, the current row comprising the plurality of fields;
generating, by the feature tokenizer, a current plurality of field token vectors that corresponds to a current plurality of original field values of the current row;
generating, by the transformer, a current plurality of transformer output values that corresponds to the current plurality of field token vectors; and
generating, by a mean pool operation, a current row embedding value for the current row, the current row embedding value being generated based on the current plurality of transformer output values.

19. The method of claim 18, wherein the second data table comprises a reference row, wherein the reference row comprises the plurality of fields, and wherein the method comprises:
after the performing of the inference operation:
generating, by the one or more hardware processors, a reference row embedding value for the reference row; and
determining, by the one or more hardware processors, a similarity between the reference row and the current row based on the reference row embedding value and the current row embedding value.

20. The method of claim 19, wherein the generating of the reference row embedding value for the reference row comprises:
generating, by the set of initial processing operations, a reference plurality of intermediate field values based on a reference plurality of original field values of the reference row;
generating, by the feature tokenizer, a reference plurality of field token vectors that corresponds to the reference plurality of intermediate field values;
generating, by the transformer, a reference plurality of transformer output values that corresponds to the reference plurality of field token vectors; and
generating, by a mean pool operation, the reference row embedding value for the reference row, the reference row embedding value being generated based on the reference plurality of transformer output values.

21. The method of claim 18, comprising:
after the performing of the inference operation:
determining, by the one or more hardware processors, a distance between the current row embedding value and a nearest neighbor row in the first data table of the training data;
determining, by the one or more hardware processors, whether the distance satisfies a distance threshold constraint; and
determining, by the one or more hardware processors, that the current row is anomalous in response to determining that the distance satisfies the distance threshold constraint.

22. The method of claim 18, comprising:
after the performing of the inference operation:
determining, by the one or more hardware processors, a distance between the current row embedding value and a nearest neighbor row in the first data table of the training data;
determining, by the one or more hardware processors, whether the distance satisfies a distance threshold constraint; and
determining, by the one or more hardware processors, that the current row is not anomalous in response to determining that the distance does not satisfy the distance threshold constraint.

23. A computer-storage medium comprising instructions that, when executed by one or more processors of a machine, configure the machine to perform operations comprising:
accessing training data that comprises a data table, the data table comprising a set of rows that store data, each row of the set of rows comprises a plurality of fields; and
for a select row of the set of rows:
generating, by a set of initial processing operations, a select plurality of intermediate field values based on a select plurality of original field values of the select row, the set of initial processing operations being configured to generate the select plurality of intermediate field values by replacing a set of original categorical values of a set of randomly-selected categorical fields of the select row in the select plurality of intermediate field values with a set of replacement categorical values;
generating, by a feature tokenizer, a select plurality of field token vectors based on a select plurality of intermediate field values;
generating, by a transformer, a select plurality of transformer output values based on the select plurality of field token vectors;
generating, by a set of prediction layers, a set of prediction values based on the select plurality of transformer output values, a select prediction value in the set of prediction values corresponding to a randomly-selected categorical field of the set of randomly-selected categorical fields, the select prediction value indicating whether an original categorical value of the randomly-selected categorical field was replaced; and
training the transformer or the set of prediction layers based on the set of prediction values by adjusting one or more parameters of at least one of the transformer or the set of prediction layers based on the set of prediction values.

24. The computer-storage medium of claim 23, wherein a select prediction value in the set of prediction values corresponds to a randomly-selected categorical field of the set of randomly-selected categorical fields, the select prediction value indicating whether an original categorical value of the randomly-selected categorical field was replaced.

25. The computer-storage medium of claim 24, wherein the adjusting of the one or more parameters based on the set of prediction values comprises:
comparing the select prediction value to an expected value for the randomly-selected categorical field, the expected value indicating that an original categorical value of the randomly-selected categorical field was replaced; and
adjusting the one or more parameters based on the comparing of the select prediction value to the expected value.

26. The computer-storage medium of claim 23, wherein the set of initial processing operations is configured to generate the select plurality of intermediate field values by replacing, in the select plurality of intermediate field values, a set of original numerical values of a set of randomly-selected numerical fields of the select row with a set of masked values.

27. The computer-storage medium of claim 26, wherein the set of prediction values comprises a given prediction value corresponding to a randomly-selected numerical field of the set of randomly-selected numerical fields, and wherein the adjusting of the one or more parameters based on the set of prediction values comprises:
comparing the given prediction value to an original numerical value of the randomly-selected numerical field; and
adjusting the one or more parameters based on the comparing of the select prediction value to the original numerical value.

28. The computer-storage medium of claim 23, wherein the feature tokenizer and the transformer are part of a feature-tokenizer transformer (FTT).

29. The computer-storage medium of claim 23, wherein the data table is a first data table, and wherein the operations comprise:
after the training of the transformer based on the set of prediction values, performing an inference operation using the transformer, the inference operation comprising:
accessing input data that comprises a second data table, the second data table comprising a current row, the current row comprising the plurality of fields;
generating, by the feature tokenizer, a current plurality of field token vectors that corresponds to a current plurality of original field values of the current row;
generating, by the transformer, a current plurality of transformer output values that corresponds to the current plurality of field token vectors; and
generating, by a mean pool operation, a current row embedding value for the current row, the current row embedding value being generated based on the current plurality of transformer output values.

30. The computer-storage medium of claim 29, wherein the second data table comprises a reference row, wherein the reference row comprises the plurality of fields, and wherein the operations comprise:
after the performing of the inference operation:
generating a reference row embedding value for the reference row; and
determining a similarity between the reference row and the current row based on the reference row embedding value and the current row embedding value.
